(19) United States
(12) Patent Application Publication
(10) Pub. No.: US 2024/0149606 A1
(43) Pub. Date: May 9, 2024

(54) PAINTER'S COLOR DIARY

(71) Applicant: Heather E. Goldstein, Raleigh, NC (US)

(72) Inventor: Heather E. Goldstein, Raleigh, NC (US)

(21) Appl. No.: 17/982,776

(22) Filed: Nov. 8, 2022

(51) Int. Cl. B44D 3/00; B42F 3/06

(52) U.S. Cl. CPC B44D 3/003; B42F 3/06

(57) ABSTRACT

A binder for artists to record and retrieve color formulations comprises a plurality of sheets of paper that are adapted to accept both paint and text that relates to the specifics of a particular paint formula. Paint impermeable interleafing sheets are positioned between and overlie the respective sheets of paper to prevent bleeding between adjacent sheets. The sheets of paper and the interleafing sheets are adapted to be positioned between a front cover and a rear cover. The sheets of paper, the interleafing sheets, and the front cover and the rear cover are connected to a binding that holds the foregoing together. The sheets of paper are constructed and arranged to be removed and reinserted into the binding between the adjacent glassine interleafing sheets so that reinsertion after use, the applied paint can dry without smudging or contaminating adjacent sheets of paper.

### FIELD OF THE INVENTION

This invention relates generally to the field of notebooks for recording information for future use and, more particularly, to a notebook or diary for artists to record and recall for future use colors and the particular paint mixtures used to achieve the colors.

### BACKGROUND OF THE INVENTION

Artists employ “mediums” such as oil paints, watercolor paints, and acrylic paints in the creation of their works. The aforementioned mediums or paints are applied to a variety of substrates, for example, conventional pulp paper, cotton or “rag” paper, canvas, linen, wood, metal, or virtually any surface. Each of these surfaces accepts paints differently and has different drying times. The drying time is also a function of many factors such as temperature, humidity, and type of paint as well, as other factors.

In view of the foregoing, artists may have to stop or pause moving forward on a painting based on one or more of the above factors. Additionally, artists will often simultaneously work on multiple pieces or pause working due to fatigue, mental blocks, or personal outside time demands. It would therefore be advantageous for artists to be able to record paint colors and how they were mixed so that when they return to complete a painting, the previously employed color(s) can be recreated.

Additionally, artists and particularly art students, experiment with paints in a variety of ways, for example, swatching colors and new paint colors, testing paints for color transparency and opacity, practicing grey values, practicing tints or shades of colors, and testing color palettes for a planned or upcoming painting. In view of the foregoing, it would be useful for artists to have a system for recording this data for future use and for being able to easily retrieve it when needed.

In view of the foregoing, it is an object of the present invention to provide an improved product for artist color recordation reference and future retrieval.

Another object of the present invention is to provide an improved product for an artist to record color swatches for future reference and retrieval.

Yet another object of the present invention is to provide an improved product for artists to record color transparency and opacity for future reference and retrieval.

Still another object of the present invention is to provide an improved product for artists to create and record color mixing formulas so that they can be retrieved for future use.

A still further object of the present invention is to provide an improved product for testing color transparency and opacity and for practicing tints and shades of colors.

### SUMMARY OF THE INVENTION

The benefits and advantages of the present invention are achieved in an artist's color binder. In the diary, artists can record, store and retrieve reference paint formulations. The diary comprises a plurality of sheets of paper adapted to accept both paint and text related to the specifics of a particular paint formula. Paint impermeable interleafing sheets, preferably of glassine, are positioned between and overlay the respective sheets of paper to prevent bleeding between adjacent sheets. The sheets of paper and the interleafing sheets are adapted to be positioned between a front cover and a rear cover. The sheets of paper, the interleafing sheets, the front cover, and the rear cover are connected to a binding that holds the foregoing together. In another aspect of the invention, the sheets of paper are constructed and arranged to be removed and reinserted into the binding between the adjacent glassine interleafing sheets so that reinsertion after use, the applied paint can dry without smudging or contaminating adjacent sheets of paper.

### BRIEF DESCRIPTION OF THE DRAWINGS

Some of the features and advantages of the invention having been briefly stated, others will appear from the detailed specification which follows, when taken in connection with the accompanying drawings in which:

FIG. 1 is a plan view of an oil or acrylic paint diary sheet detachably connected to the wire comb binding according to the present invention.

FIG. 2 is a plan view of a watercolor paint diary sheet detachably connected to the wire comb binding according to the present invention.

FIG. 3 illustrates the tabs of a sheet inserted within the combs of the wire comb binding according to the present invention.

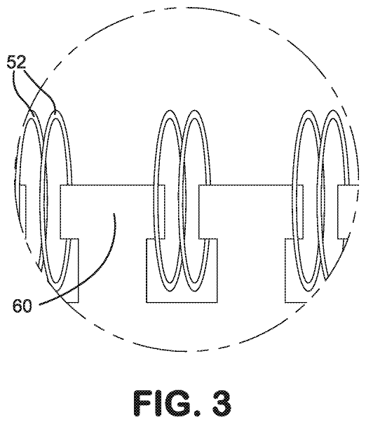

FIG. 4 illustrates multiple diary sheets and interleaving sheets connected to the wire comb binding according to the present invention.

FIG. 5 is a perspective view, partially broken away, of the complete color diary showing the cover, diary sheet and interleaving sheet, and rear cover.

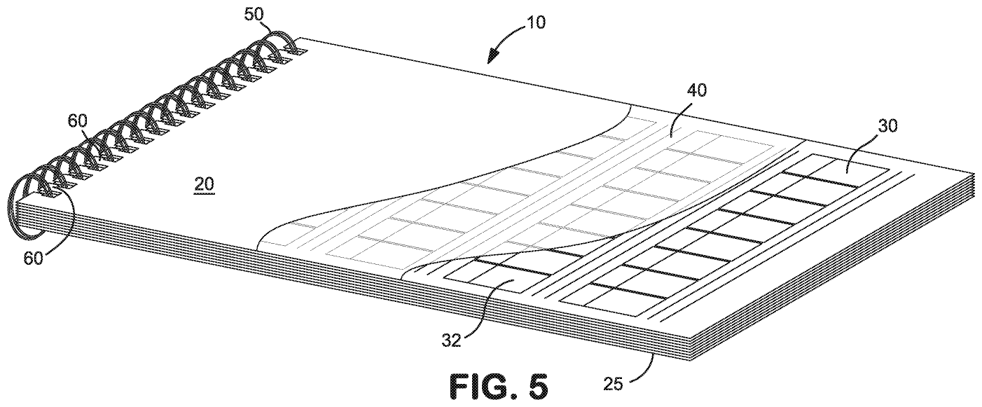

### DETAILED DESCRIPTION OF THE ILLUSTRATED EMBODIMENTS

While the present invention will be described more fully hereinafter with reference to the accompanying drawings, in which particular embodiments are shown, it is to be understood at the outset that persons skilled in the art may modify the invention herein described while still achieving the favorable results of this invention. Accordingly, the description which follows is to be understood as a broad teaching disclosure directed to persons of skill in the appropriate arts and not as limited upon the present invention.

Referring now more particularly to the drawings, the painter's color diary generally indicated at 10 comprises a front cover 20, rear cover 25, a plurality of paint sheets 30, a plurality of interleaving sheets 40, and a wire comb binding 50.

The covers 20, 25 are preferably of a stiff material such as cardboard or heavy card stock that will maintain the stiffness of the diary under normal working and transporting conditions. The outer surfaces of the covers may also be finished and contain illustrations on how the diary can be employed. In the preferred embodiment, the covers 20, 25 also include tabs 60 that enable the covers to be detached and reinserted into the binding. Notwithstanding the foregoing, the covers 20, 25 may be fabricated with openings that fit within the wire binding that make them permanently attached.

Interleaving sheets 40 are connected to the wire binding 50 by a plurality of tabs 60 along one edge thereof. The sheets 40 may be fabricated from any material that is nonpermeable to the paint and has a surface to which the paint will not stick. In the present invention, this material is commonly referred to as “glassine,” which is a thin dense transparent, or semitransparent paper that is highly resistant to the passage of air and grease (and paint). The interleaving sheets are smooth and have a neutral pH which prevents painted pages from sticking to the sheet above and also protects the paint sheets from rubbing, dirt and spills.

The diary sheets 30 are of two types, the first watercolor paints and the second for oil and acrylic paints, as the respective paints have different characteristics that necessitate papers with different properties.

In the preferred embodiment for watercolor paints, one hundred percent (100%) cotton mold-made paper is used. To reproduce the truest colors for reference guides, bright white paper is used. In addition, unlike normal watercolor papers, the paper is internally and externally sized to prevent warping and makes it ideal for not only watercolor but also gouache, tempera, ink, watercolor pencils, water-soluble crayons, oil pastels, chalk pastels, graphite, and charcoal. Another factor that allows the paper to readily accept such a wide variety of mediums is that it is processed through wool felt rollers that give it its unique texture. The randomly dispersed fibers become interwoven as they pass through the rollers, and this provides additional interstitial space between fibers that retain or “lock in” the medium.

The paper employed for oil and acrylic paints is also rolled one hundred percent (100%) cotton, however, in this case, the paper is internally sized so that the sizing completely penetrates into the paper fibers. The sizing is a combination of rosin, synthetic and neutral sizing, which allows the paper to handle acrylic paints in a manner similar to “canvas pads” as well as oil paints.

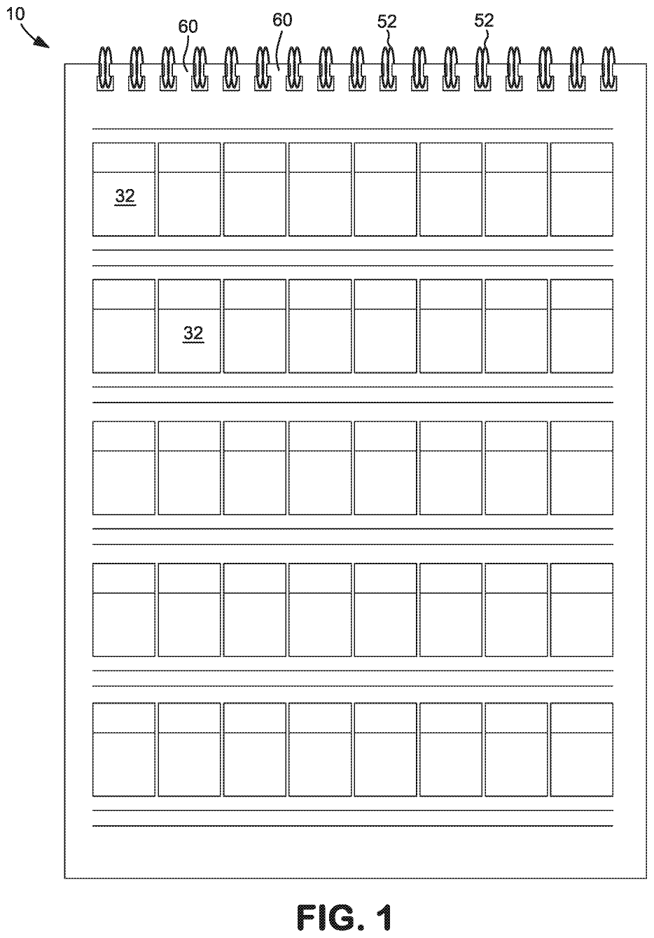

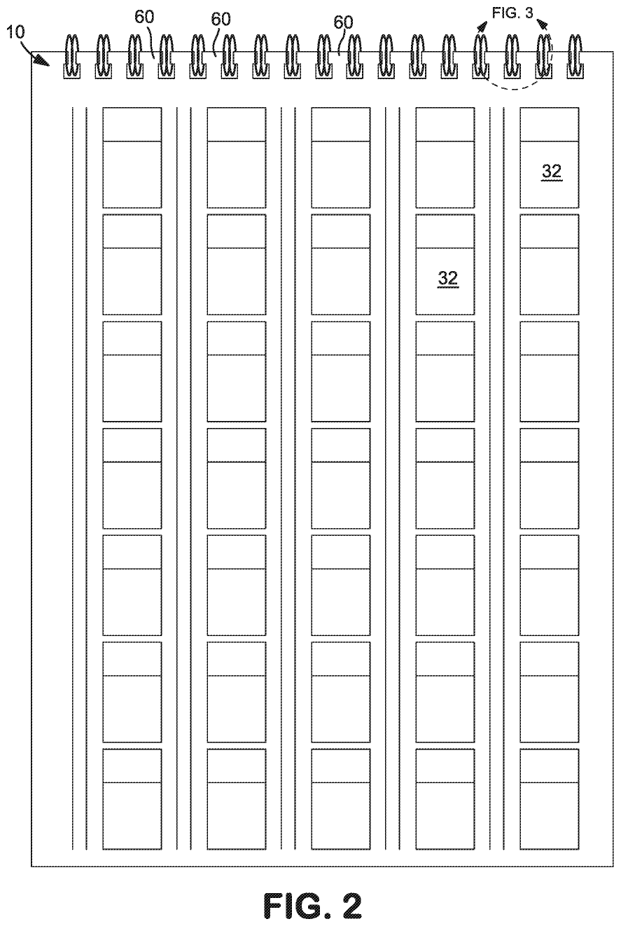

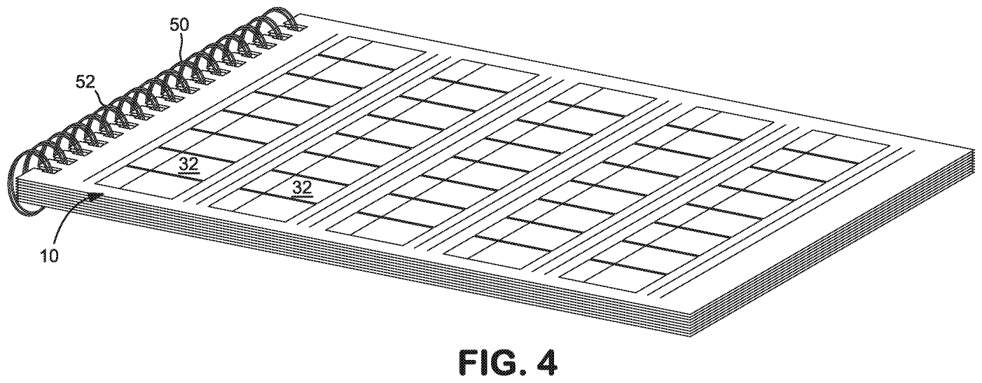

Each diary sheet 30 includes a plurality of “color diary blocks” or swatch boxes 32 which are divided into two sections, the larger area is for the paint reference color to be recorded, and the smaller section is for writing the color formulation. The oil and acrylic pages are oriented perpendicular to the wire binding 50, as shown in FIGS. 1 and 4, and the watercolor sheets are oriented parallel to the wire binding 50, as shown in FIG. 2. It is self-evident that the color diary blocks 32 may be configured differently than the illustrated embodiment and should be considered within the scope of this invention.

Each element of the color diary has a series of tabs 60 along one edge that are adapted to be detached and reinserted within a corresponding adjacent wire pair 52 of the comb binding 50. The diary sheets 30 are specifically outfitted in this manner as an artist may be simultaneously recording color formulation on multiple sheets in connection with multiple projects.

In operation, the artist may open the cover and turn to the desired diary sheet, which may or may not be removed. The reference color or colors are applied to the particular block, and the respective formulations are recorded in the corresponding swatch box. The sheet may then be allowed to dry and inserted back into the diary or reinserted while wet or damp and covered with the corresponding glassine sheet without fear of bleed through or smudging.

The foregoing embodiments and examples are to be considered illustrative rather than restrictive of the invention, and those modifications which come within the meaning and range of equivalence of the claims are to be included therein.

1. A binder for artists to record, store, record, and retrieve reference paint formulations and comprising:
a plurality of sheets of paper and wherein each of the sheets of paper is adapted to accept both paint and text so that an artist may apply a paint color thereto and write thereon the corresponding color formulation; and
a plurality of interleafing sheets positioned between and overlying the respective sheets of paper; and
a front cover and a rear cover and wherein the sheets of paper and the interleafing sheets are adapted to be positioned therebetween; and
a binding constructed and arranged to connect to the front and rear covers, the respective sheets of paper, and the interleafing sheets and wherein the binding comprises a wire comb binding of the type having a plurality of spaced apart wire loop pairs, and further the respective sheets of paper have tabs along one edge thereof, the tabs being adapted to be detachably and re-insertingly connected to a corresponding wire pair; and
wherein the sheets of paper are constructed and arranged to be removed and reinserted into the binding between the adjacent interleafing sheets;
whereby upon reinsertion, after use, the applied paint can dry without smudging or contaminating adjacent sheets of paper.

2. (canceled)

3. The binder of claim 1, wherein the paper is textured and sized to accept acrylic paints, oil paints, or a combination thereof.

4. The binder of claim 1, wherein the paper is textured and sized to accept watercolor paints.

5. The binder of claim 1, wherein the paper is textured and sized to accept oil and acrylic paints.

6. The binder of claim 1, wherein the paper further includes a plurality of paint recording areas and proximate thereto corresponding areas for recording related paint data.

7. The binder of claim 5, wherein the paper for oil paints and acrylic paints is in a range of between 100 lbs. and 150 lbs.

8. The binder of claim 4, wherein the paper for watercolor paints has internal and external sizing.

9. The binder of claim 6, wherein the paint recording areas comprise swatch boxes and a respective adjacent data recording area.

10. The binder of claim 1, wherein the interleafing sheet is glassine.

11. A binder for artists to record, store, record, and retrieve reference paint formulations and comprising:
a plurality of sheets of paper and wherein each of the sheets of paper is textured and sized to enable the respective sheets to accept both paint and text so that an artist may apply a paint color thereto and write thereon the corresponding color formulation, and
the sheets of paper further including a plurality of paint recording areas and proximate thereto corresponding areas for recording related paint data and wherein the paint recording areas and areas for recording related paint data comprise a plurality of swatch boxes, the swatch boxes being divided into distinct areas for recording paint and a second area for writing the corresponding color formulation;
a plurality of glassine sheets positioned between and overlying the respective sheets of paper; and
a front cover and a rear cover and wherein the sheets of paper and the interleafing plurality of glassine sheets are adapted to be positioned therebetween; and
a binding constructed and arranged to connect to the front and rear covers, the respective sheets of paper, and the interleafing sheets; and
wherein the sheets of paper are constructed and arranged to be removed and reinserted into the binding between the adjacent interleafing sheets;
whereby upon reinsertion, after use, the applied paint can dry without smudging or contaminating adjacent sheets of paper.

12. (canceled)

13. The binder of claim 11, wherein the swatch boxes are arranged linearly in rows.
